(19) United States
(12) Patent Application Publication
(10) Pub. No.: US 2013/0009809 A1
(43) Pub. Date: Jan. 10, 2013

(54) Multi-Spot Satellite System with Efficient Space Resource Allocation

(75) Inventors: Pascal BERT, Balma (FR); Didier DELMAS, Toulouse (FR); Philippe VOISIN, Toulouse (FR)

(73) Assignee: THALES, Neuilly-sur-Seine (FR)

(21) Appl. No.: 13/179,417

(22) Filed: Jul. 8, 2011

(51) Int. Cl. H04B 7/185

(52) U.S. Cl. 342/354

(57) ABSTRACT

A satellite system comprises at least one satellite that receives and transmits signals from/to user terminals located in a service area covered by a plurality of beams, frequencies used in each beam being allocated in order to allow frequency reuse. The beam sizes, the bandwidth used in each beam and the power density in each beam are chosen as a function of the user density in the service area.

### FIELD OF THE INVENTION

This invention relates to a multi-spot satellite system with efficient space resource allocation and is particularly, but not exclusively, applicable to telecommunications satellites.

### BACKGROUND

Satellite based systems can be used to provide multimedia digital services over large geographical areas. Those are particularly useful to cover large areas with low population density and distant from urban centres. If satellites are not used, the access to digital services will require a ground infrastructure implying high investment costs for low profitability.

In order to cover a given service area, most of broadband satellites systems make use of a multi-beam architecture that provides means to reuse frequencies.

Existing solutions are mostly based on one or several geostastionary satellites. For example, a service area can be covered by one satellite that uses a plurality of beams, a beam being associated to a spot. A spot is an area covered thanks to one of the system's beam. The service area is usually covered by a plurality of spots.

For a given frequency bandwidth allocated to such a satellite system, an efficient frequency use can be achieved by applying the well known four-color theorem. In that case, the bandwidth allocated to the system is splitted into four portions called colors, each spot being associated to one color. This allows the reuse of the same frequencies in different spots.

Most of the existing systems are based on a regular grid mesh where beam sizes and allocated bands per beam are even over the service area. An example is illustrated on FIG. 1 where service area 100 is split into 31 spots of 1° diameter. In this figure, the Australian territory is taken as an example of service area. The same service area can also be covered by using smaller size spots. FIG. 2 gives an example where the same service area 100 split into 235 spots of 0.35° diameter. Using smaller spots allows to increase the system capacity in the service area 200 and thus the number of users that can access to the provided services.

The user geographical distribution is the key driver to estimate the capacity required over a given service area. As illustrated on FIGS. 1 and 2, the spectrum distribution of the system can be adapted by choosing different spot sizes with a ratio of 1 to nearly 8. This is possible as the beam size can usually vary from ˜0.35° to ˜1°.

The consequences of increasing the number of beams by using smaller spot size is that more ground stations transmitting towards the satellites are required, and the interference level increases significantly. The said stations are called gateways in the sequel. Another consequence is that the cost and complexity of the system are increased as well as the satellite's payload size and complexity.

FIG. 3 is a schematic representation of the user geographical distribution over the Autralian territory. The first two axes 300, 301 represent longitude and latitude. The third axis 302 shows the ratio between the lowest throughput and the highest throughput required in the service area. If the lowest required throughput is normalized to 1, the highest required throughput exceeds 300. Therefore, the ratio between low populated areas and dense urban areas is far higher than 8. The major concern of the existing satellite system is that the achievable throughput ratios cannot satisfy such range of densities. Therefore, the systems are usually designed to serve the densest areas. It leads to unused space resources such as frequency and transmission power. In other words, those systems are oversized, that is to say that they use more band and more ground infrastructure than required. These solutions are operational but not optimized in terms of capital expenditure and operating expense. There is nowadays a strong market need of two ways broadband systems that are able to serve a very high uneven distribution of users by satellite with an optimum use of the available space resource.

### SUMMARY OF THE INVENTION

According to the invention, there is provided a satellite system comprising at least one satellite that receives and transmits signals from/to user terminals located in a service area covered by a plurality of beams, frequencies used in each beam being allocated in order to allow frequency reuse. The beam sizes, the bandwidth used in each beam and the power density in each beam are chosen as a function of the user density in the service area.

According to a complementary aspect, a plurality of on board power amplifiers are used by the satellite to generate a different density of power distribution for each beam or for different subsets of beams.

The satellite system may use adaptative modulation and coding, the use of a given adaptative modulation and coding scheme being promoted in a beam by choosing an appropriate power density value.

A system according to any one of the preceding claims, wherein the system frequency plan is based on a frequency reuse scheme at least four colours.

In a preferred embodiment, a plurality of beam sizes are used in a ratio of 5 between the smallest and the biggest.

According to an other aspect of the invention, the chosen power densities are chosen on a 6 dB range.

### BRIEF DESCRIPTION OF THE DRAWINGS

A better understanding of the embodiments of the present invention can be obtained from the following detailed description in conjunction with the following drawings, in which:

FIG. 1 is an illustration of a conventional 31 spots coverage where a 1° beam size is used;

FIG. 2 is an illustration of a conventional 235 spots coverage where a 0.35° beam size is used;

FIG. 3 is a schematic representation of the user geographical distribution over the Autralian territory;

FIG. 4 illustrates an example of the system architecture according to the invention;

FIG. 5 illustrates how frequency resources can be used by the system according to the invention;

FIG. 6 illustrates the impact of using different power densities for the system beams;

FIG. 7 is a flow diagram illustrating a method that can be used to allocate spatial resources for a system according to the invention;

FIG. 8 gives a schematic representation of a repeater that can be embedded in a satellite belonging to the system according to the invention.

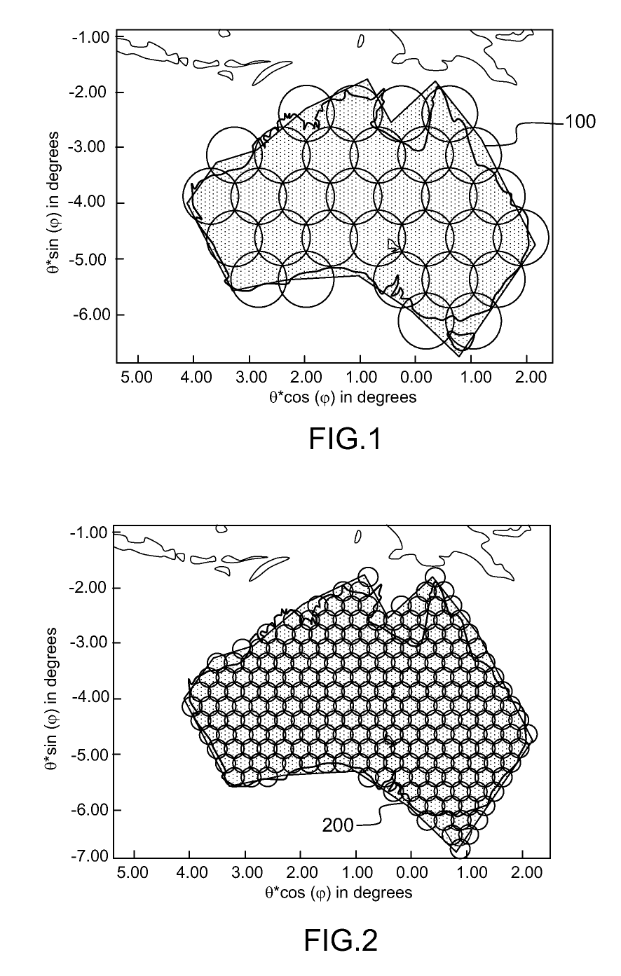

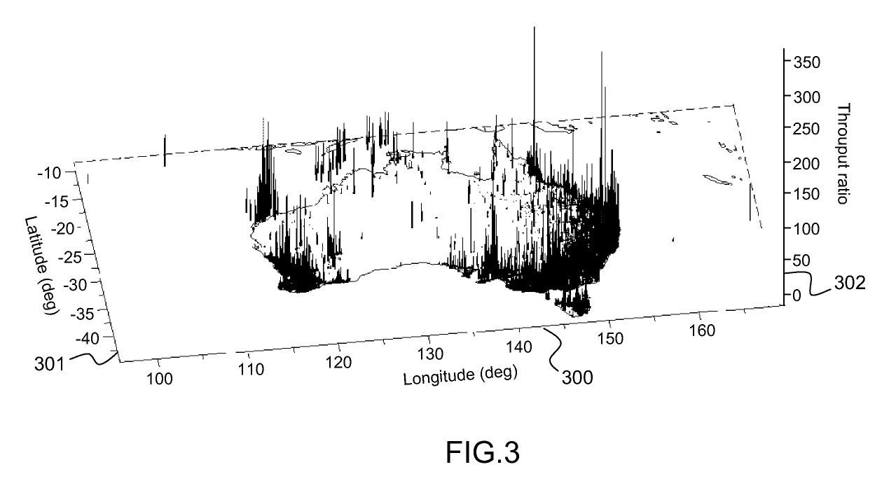

### DETAILED DESCRIPTION

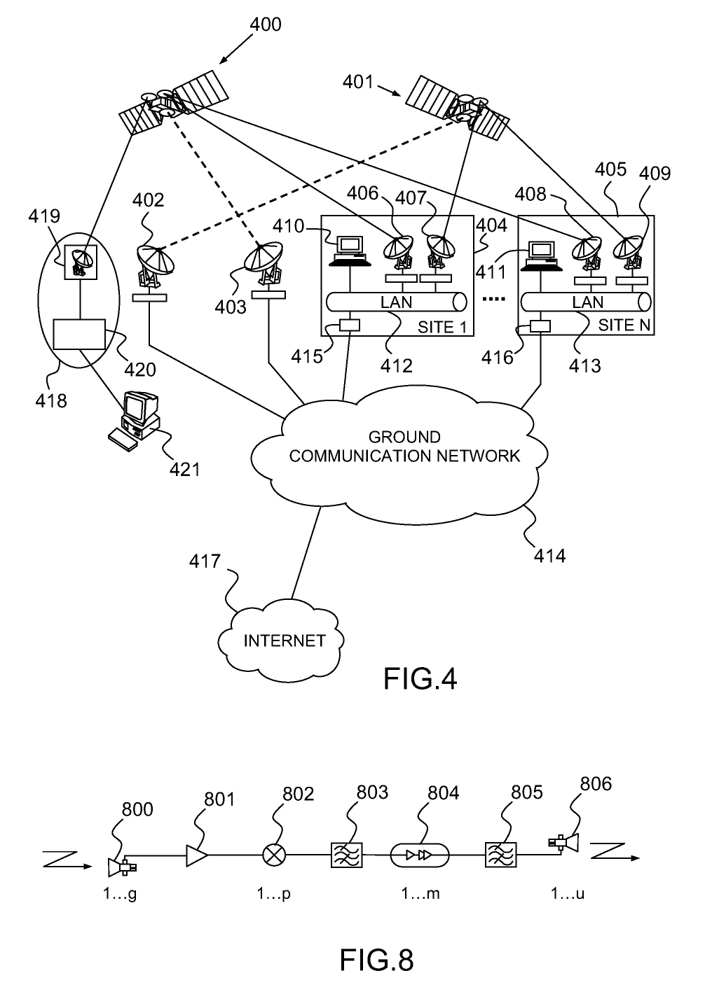

FIG. 4 illustrates a preferred embodiment of the invention. In this embodiment, the system comprises two satellites 400, 401. A Telemetry, Command and Ranging TCR subsystem provides position and state control of the satellites 400, 401 by using two ground stations 402, 403. The system comprises also N sites 404, 405, each of them comprising two gateways 406, 407, 408, 409 that manage the interface between the system and external networks. Control stations 410, 411 control each site's gateway 406, 407, 408, 409. The said control stations 410, 411 communicate with gateways via a local access network LAN 412, 413. For example, the LAN network allows each site 404, 405 to communicate with a ground communication network GCN 414 using routers 415, 416. TCR ground stations 402, 403 may be linked to the GCN 414 as well. The GCN network is also connected to one or several external network such as Internet network 417. This allows one or several Very Small Aperture Terminal VSAT 418 to access multimedia services provided by the said external networks 417. As a reminder, a VSAT 418 is usually composed of an Outdoor Unit ODU 419 and an Indoor Unit IDU 420. A user terminal 421 can then be connected to the IDU 420, the said user terminal allowing users to access to various kinds of multimedia services.

Advantageously, the second satellite can be added later to the system in order to double the capacity. The two satellites will have the same architecture, which will reduce the engineering costs. Additionally, if one of the satellites breaks down, the system remains operational.

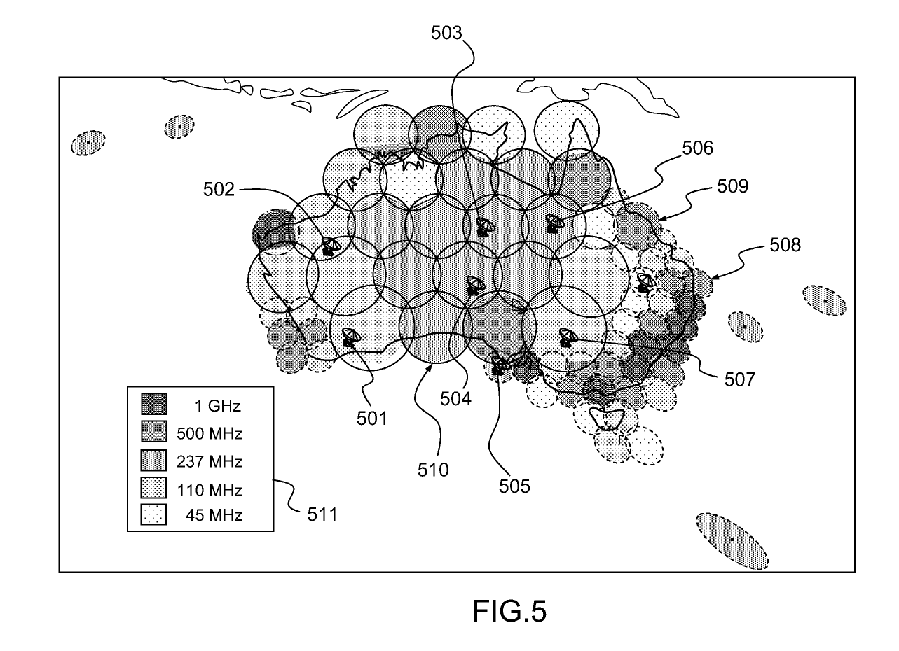

FIG. 5 illustrates how frequency resources can be used by the system according to the invention. In order to optimize the use of space resources over a given service area, the system uses different beams sizes.

In this specification, the expression “space resources” embraces frequency, transmission power and beam/spot size.

Three beam sizes can be chosen, for example 0.4°, 0.7° and 1°. Those values are given only as an example. Other values as well as a different number of spot sizes can be used, for example in a ratio of 5 between the smallest and the bigger spots.

Additionally, the system uses a frequency bandwidth allocation in which contiguous beams are using different frequencies, even those that have the same size. To do so, an efficient frequency plan needs to be set up in order to fit the frontier between large beams and small beams and to limit the internal interferences in the system. The frequency plan is based for example on a four colour basic scheme. Further, additional sub-colors may be used inside an existing color.

According to a complementary aspect of the invention, different power densities can be used for different beams and/or sub-sets of beams. For that purpose, several Travelling Wave Tube Amplifiers TWTA can be used for different portions of the system bandwidth in order to generate various densities of power distribution in every spots or in different sub-set of spots of the system. For example, if three distinct 500 MHz bandwidth are used for three contiguous spots, one of the combinations below can be chosen:
one TWTA is used for 2 spots to amplify over a 1 GHz bandwidth and a second TWTA is used to amplify over 500 MHz bandwidth;
a single TWTA is used for the three spots; as a consequence, it should be able to amplify signals over a 1.5 GHz bandwidth;
two TWTAs are allocated per 500 MHz; in that case, a total of six TWTAs are required to serve the three spots.

During the system conception, gateways 501, 502, 503, 504, 505, 506, 507 should be located carefully so that they do not interfere with each other. Additionally, the boresight of the antennas gateways 406, 407, 408, 409 can be located so that they can transmit a beacon to the satellite for its Antenna Pointing System. This enables to make use of small size beams.

The gateways can be located close to existing infrastructures such as networks, facilities and power supplies in order to optimize deployment and operational costs.

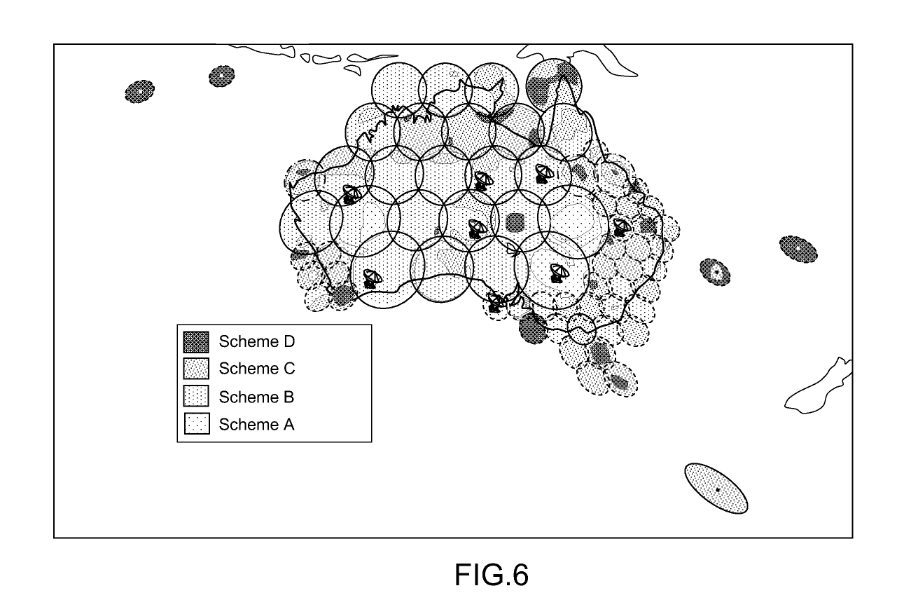

FIG. 6 illustrates the impact of using different power densities for the system beams. Beam sizes and allocated frequencies are the same as those presented on FIG. 5. The system according to the invention can use Adaptative Modulation and Coding ACM technique that aims to automatically select the most suitable combination of modulation and redundancy for the user communications. Those combinations are called schemes in the sequel. For example, a scheme is considered suitable when the quality in term of bit error rate is sufficient while the throughput is maximised. In the example of FIG. 6, four different schemes are used, namely A, B, C and D. Scheme A is the scheme that provides the highest throughput while scheme D provides the lowest. The system according to the invention can use different power densities for each beam. This means that the use of a chosen scheme can be promoted by allocating a given power density per beam. Thus, by selecting a beam size, a bandwidth and a power density, a target throughput can be guaranteed in a spot taking into account the user density in a given service area.

As an example, the above schemes can be used:
M=16-APSK; R=5/6
M=16-APSK; R=4/5
M=16-APSK; R=3/4
M=16-APSK; R=2/3
M=8-PSK; R=3/4
M=8-PSK; R=3/5
M=QPSK; R=5/6
M=QPSK; R=3/4
M=QPSK; R=2/3
M=QPSK; R=3/5
M=QPSK; R=1/2
M=QPSK; R=1/3
M=QPSK; R=1/4
   where:
   M denotes the modulation scheme;
   R denotes coding rate;
   16-APSK denotes the 16 states Amplitude and Phase Shift Keying modulation;
   8-PSK denotes the 8 states Phase Shift Keying modulation;
   QPSK denotes the Quadrature Phase Shift Keying modulation.

The use of those schemes leads to efficiencies varying from 1 to 6.6, that is to say from 0.5 bits per symbol for M=QPSK, R=1/4 to a 3.3 bits per symbol for M=16-APSK and R=5/6.

Considering that the system allows the use of different spot sizes, different bandwidth sizes in a spot and different power densities in one or several spots, the solution proposed by the invention enables to address throughput ratio variations going from 1 to more than 300 depending on the user densities in the service area.

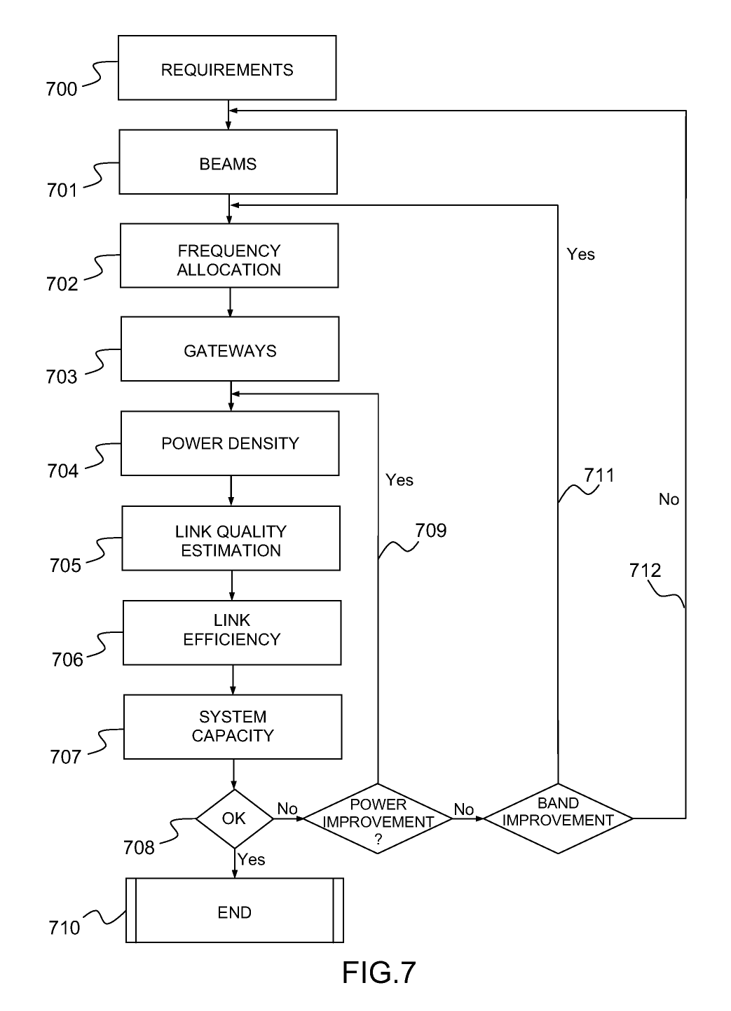

FIG. 7 is a flow diagram illustrating a method that can be used to allocate space resources for a system according to the invention.

A first step 700 consists into analyzing system requirements such as the service area size and the user density over the said area. Then, the number of beams and the beams sizes are chosen 701 in order to cover the entire service area. A portion of the available bandwidth is allocated 702 for each beam taking into account frequency reuse and the throughput required in each beam. For example, a bandwidth of 62.5 MHz, 125 MHz, 250 MHz, 500 MHz or 1 GHz can be allocated for each beam. It is then possible to determine how many gateways are required 703 and to locate them. Then, different power densities can be chosen for each beam 704. High power densities can be allocated to areas where the user density is high. In a preferred embodiment, a power density varying on_a 6 dB range can be used. Once the beams sizes, the bandwidths and the power densities have been chosen, it is possible to estimate the link quality 705 over the service area. For that purpose, the carrier to noise and interference ratio CNIR can be estimated. It is possible to assess the link efficiency 706 by taking into account the ACM schemes that are used over the service area. Finally, the system capacity 707 is deduced from the estimated link efficiency and from the allocated bandwidth. It is possible to verify 708 if the system requirements are fulfilled. If not, the power densities 709 and/or the allocated bandwidth 710 can be adapted and the system capacity re-estimated 705, 706, 707. The number of beams and the beams sizes can be adapted too 712. A system-planning tool can implement this method.

FIG. 8 gives a schematic representation of a repeater that can be embedded in a satellite belonging to the system according to the invention.

This repeater is used by the satellite to retransmit signals received from gateways towards the correct spots. For that purpose, the repeater comprises for example g RF receivers 800, where g is the number of gateways used in the system. The g RF signals are then amplified by using g Low Noise Amplifiers LNA 801. A set of p local oscillators LO can be used for frequency conversion purpose. Signals resulting from this frequency conversion can be filtered by using bandpass filters 803. In order to amplify the filtered signals with the aim to introduce different power densities in the spots, m High Power Amplifier HPA 804 can be used. For that purpose, a TWTA and can be used for one or several spots. The gain of each TWTA can be controlled independently. If a TWTA is used for more than one spot, the said spots may have different frequencies allocated to each of them. After the amplification 804, a plurality of bandpass filters 805 as well as u RF transmitters 806 are used to transmit the signal in the spots of the system, u being the number of spots that are covering the service area.

As noted above, the system and method described are merely exemplary and the skilled person would appreciate that a number of alternatives exist to implement aspects of the invention. Embodiments of the invention may be also used in a wide variety of applications and contexts, wherever multi-spots satellite communications may be required. It will also be apparent to the skilled person that various sequences and permutations on the system and method described are possible within the scope of this invention as disclosed.

1- A satellite system comprising at least one satellite that receives and transmits signals from/to user terminals located in a service area covered by a plurality of beams, frequencies used in each beam being allocated in order to allow frequency reuse, wherein the beam sizes, the bandwidth used in each beam and the power density in each beam are chosen as a function of the user density in the service area.

2- A satellite system according to claim 1, wherein a plurality of on board power amplifiers are used by the satellite to generate a different density of power distribution for each beam or for different subsets of beams.

3- A satellite system according to claim 1, wherein the system uses adaptative modulation and coding, the use of a given adaptative modulation and coding scheme being promoted in a beam by choosing an appropriate power density value.

4- A satellite system according to claim 1, wherein the system frequency plan is based on a frequency reuse scheme at least four colours.

5- A satellite system according to claim 1, wherein a plurality of beam sizes are used in a ratio of 5 between the smallest and the biggest.

6- A satellite system according to claim 1, wherein the chosen power densities are chosen on a 6 dB range.

7- A satellite that receives and transmits signals from/to user terminals located in a service area covered by a plurality of beams, frequencies used in each beam being allocated in order to allow frequency reuse, wherein the beam sizes, the bandwidth used in each beam and the power density in each beam are chosen as a function of the user density in the service area.

8- A satellite according to claim 7, wherein a plurality of on board power amplifiers are used to generate a different density of power distribution for each beam or for different subsets of beams.

9- A satellite according to claim 7 wherein the satellite uses adaptative modulation and coding, the use of a given adaptative modulation and coding scheme being promoted in a beam by choosing an appropriate power density value.

10- A satellite according to claim 7, wherein a plurality of beam sizes are used in a ratio of 5 between the smallest and the biggest.

11- A satellite according to claim 7, wherein the chosen power densities are chosen on a 6 dB range.
